(19) United States
(12) Patent Application Publication
(10) Pub. No.: US 2026/0257663 A1
(43) Pub. Date: Sep. 3, 2026

(54) INTERFACE CONTROLLER, ENERGY-STORAGE DEVICE, DRIVE-TRAIN ASSEMBLY, METHOD FOR RETROFITTING AND OPERATING A DRIVE TRAIN INCLUDING AN ENERGY-STORAGE DEVICE, COMPUTER PROGRAM AND ELECTRONIC STORAGE DEVICE

(71) Applicant: Rolls-Royce Solutions GmbH, Friedrichshafen (DE)

(72) Inventor: Alexander Richter, Oberwürschnitz (DE)

(73) Assignee: Rolls-Royce Solutions GmbH, Friedrichshafen (DE)

(21) Appl. No.: 19/655,374

(22) Filed: Apr. 22, 2026

Related U.S. Application Data
(63) Continuation of application No. PCT/EP2024/086967, filed on Dec. 17, 2024.

(30) Foreign Application Priority Data
Dec. 21, 2023 (DE) 10 2023 136 388.3
Dec. 17, 2024 (WO) PCT/EP2024/086967

(51) Int. Cl. B60W 20/15; B60W 50/00

(52) U.S. Cl. CPC B60W 20/15; B60W 50/00; B60W 2050/0008; B60W 2520/105

(57) ABSTRACT

An interface control device includes: the interface control device, which is configured for integrating at least one energy storage device for selectively storing a drive energy in, and delivering the drive energy to, a drive train, the interface control device including at least one first interface which is configured for receiving at least one demand parameter of the drive train, the interface control device being configured for specifying, depending on the at least one demand parameter, at least one hybrid control parameter for operating the at least one energy storage device.

### CROSS REFERENCE TO RELATED APPLICATIONS

This is a continuation of PCT application no. PCT/EP2024/086967, entitled "INTERFACE CONTROLLER, ENERGY-STORAGE DEVICE, DRIVE-TRAIN ASSEMBLY, METHOD FOR RETROFITTING AND OPERATING A DRIVE TRAIN COMPRISING AN ENERGY-STORAGE DEVICE, COMPUTER PROGRAM AND ELECTRONIC STORAGE DEVICE", filed December 17, 2024, which is incorporated herein by reference. PCT application no. PCT/EP2024/086967 claims priority to German patent application no. 10 2023 136 388.3, filed December 21, 2023, which is incorporated herein by reference.

### BACKGROUND OF THE INVENTION

### Field of the Invention

The present invention relates to drive train assemblies.

### Description of the Related Art

As part of the increasing efforts to reduce carbon dioxide emissions in all areas of technology, there is a need to be able to store amounts of energy dissipated thus far into the environment in drive trains of motor vehicles and to be able to use them at a later stage to provide drive power. For example, in a conventional dump truck with a diesel-electric drive, braking power is currently converted into heat via resistors and output to the environment, that is to say is burnt up. The replacement of drive trains already installed and in particular in operation by completely new drive trains equipped with energy storage units is complex and expensive; moreover, functional components still accumulate in excess as scrap to be disposed of, which is not sustainable. It would therefore be desirable to be able to retrofit existing drive trains of motor vehicles with energy storage units, which is difficult, however, since the respective portion of energy stored in the energy storage unit or provided from the energy storage unit must be taken into account when controlling the other components of the retrofitted drive train.

What is needed in the art is an interface control device, an energy storage device, a drive train assembly, a method for retrofitting a drive train and a method for operating a drive train in combination with an energy storage device, a computer program and an electronic storage device, wherein the aforementioned disadvantages are at least reduced and optionally do not occur.

### SUMMARY OF THE INVENTION

The invention relates to an interface control device, an energy storage device, a drive train assembly, a method for retrofitting a drive train and a method for operating a drive train in combination with an energy storage device, a computer program and an electronic storage device.

The present invention provides an interface control device for the integration of at least one energy storage device for selectively storing drive energy in and delivering same to a drive train, wherein the interface control device has at least one first interface which is set up to receive at least one demand parameter of the drive train, wherein the interface control device is set up to specify, depending on the at least one demand parameter, at least one hybrid control parameter for the operation of the energy storage device. A kind of interface is thus advantageously provided by the interface control device, which is connected between the other parts of the retrofitted energy storage device and the drive train and thus enables simple integration of the energy storage device into the existing drive train, just taking into account the portions of energy and/or power now absorbed or provided by an energy storage unit of the energy storage device. This means that existing drive trains can be retrofitted with an energy storage device simply, quickly and sustainably while maintaining their components, and so they can be operated efficiently with higher efficiency and reduced carbon dioxide emissions.

In one embodiment, the interface control device is set up to output the at least one hybrid control parameter via a second interface. As an alternative or in addition, the interface control device is set up to output the at least one hybrid control parameter to a hybrid control device of the energy storage device. In one configuration, the hybrid control device is set up, at least in one operating mode, to specify a distribution of portions of energy and/or power, on the one hand, to the drive train and, on the other hand, to the energy storage unit of the energy storage device.

In the context of the technical teaching described here, "specify" is understood in particular to mean actively determine, i.e. not "determine" in the sense of "detect" or "measure", but rather "determine" in the sense of "actively ascertain" or "calculate".

In one embodiment, the demand parameter of the drive train is selected in particular from a group consisting of an operating mode, for example decelerating or accelerating, a power demand, a speed demand, for example a setpoint speed, to be regulated, of a power device of the drive train in the form of an internal combustion engine, an excitation of an electric machine of the drive train, and a combination of at least two of these parameters.

In one configuration, the demand parameter is received by the interface control device from a drive train control device of the drive train, that is to say the interface control device receives the demand parameter from the drive train control device.

In one configuration, the energy storage device additionally has an energy storage control device. The hybrid control parameter can be output directly to the energy storage control device or it can be output to the hybrid control device, which for its part specifies, depending on the hybrid control parameter, at least one storage control parameter and outputs same to the energy storage control device.

In one configuration, the interface control device is set up to specify, depending on the at least one hybrid control parameter and/or the at least one demand parameter, at least one drive train control parameter and to output the at least one drive train control parameter – optionally via the at least one first interface or a third interface – to the drive train, in particular to a drive train control device. The interface control device can thus advantageously directly influence the control of the drive train, in particular in order to distribute a demanded power, on the one hand, to the drive train and, on the other hand, to the energy storage unit.

In one configuration, the interface control device is set up to specify, depending on the at least one demand parameter and/or the at least one hybrid control parameter, the at least one drive train control parameter for the operation of an internal combustion engine and a first electric machine of the drive train – optionally via the at least one first interface or a third interface.

As an alternative or in addition, it is possible that the hybrid control device specifies, depending on at least one parameter selected from the at least one hybrid control parameter, the at least one storage control parameter and the at least one demand parameter, the at least one drive train control parameter and outputs same to the drive train, in particular to the drive train control device, in particular in order to distribute the power.

In one configuration, the hybrid control device is set up to specify, depending on the at least one parameter selected from the at least one hybrid control parameter, the at least one storage control parameter and the at least one demand parameter, the at least one drive train control parameter for the operation of the internal combustion engine and the first electric

machine, in particular a speed demand for the internal combustion engine and an excitation for the first electric machine as the respective drive train control parameters.

According to one development of the present invention, provision is made for the interface control device to be set up to specify at least one drive train feedback parameter and to output the at least one drive train feedback parameter – optionally via the at least one first interface – to the drive train. The interface control device is thus advantageously able to give feedback to the drive train, in particular in such a way that the drive train can be operated by the drive train control device as if the energy storage device were not present.

The at least one drive train feedback parameter may be selected from a group consisting of a simulated actual speed of the internal combustion engine of the drive train, a simulated actual speed of a radiator fan of a braking resistor assembly, a simulated electrical current between a circuit breaker assembly and the braking resistor assembly, a simulated excitation of the electric machine of the drive train, a simulated electric current of the electric machine – in particular in an excitation winding, a simulated voltage of the electric machine – in particular at the excitation winding, and a combination of at least two of the parameters mentioned.

In one embodiment, the interface control device is set up to specify the at least one drive train feedback parameter depending on the at least one demand parameter and optionally depending on the at least one hybrid control parameter and/or the at least one storage control parameter.

In one configuration, the interface control device is set up to output the at least one drive train feedback parameter to a sensor input of the drive train, in particular the drive train control device. A data output of the interface control device is optionally set up to be operatively connected to a sensor input of the drive train control device in order to output the drive train feedback parameter via the data output to the sensor input. This means that the interface control device can be used to generate a – supposed or virtual – sensor signal for the operation of the drive train in order to project for the drive train control device, in one optional configuration, a behavior that would otherwise result without the use of the energy storage device.

According to one development of the present invention, provision is made for the interface control device to be set up to specify the at least one drive train feedback parameter in such a way that the function of the drive train without the at least one energy storage device is projected for the drive train control device of the drive train that receives the at least one drive train feedback parameter. This means in particular that the interface control device is used to simulate the function of the drive train without the at least one energy storage device for the drive train control device. The drive train control device thus advantageously behaves as if no retrofitting of the energy storage device had been carried out; this in turn means that there is no need to change the drive train control device to retrofit the energy storage device; instead, it can operate unchanged and can be operated as in the drive train before retrofitting. All changes and/or effects resulting from the retrofit are taken over or simulated (away) or compensated for by the interface control device. This makes it particularly easily possible to retrofit the energy storage device.

The present invention also provides an energy storage device for retrofitting on a drive train, which energy storage device includes an energy storage unit, an energy storage control device and an interface control device according to the invention which is operatively connected to the energy storage control device or an interface control device according to one or more of the previously described embodiments. In particular, the advantages which have already been explained above in conjunction with the interface control device are provided in conjunction with the energy storage device.

In one embodiment, the energy storage device additionally includes the hybrid control device which is optionally operatively connected to the interface control device, on the one hand, and to the energy storage control device, on the other hand. In particular, the interface control device is indirectly operatively connected to the energy storage control device via the hybrid control device.

According to one development of the present invention, provision is made for the energy storage device to be set up, in a deceleration mode, to regulate a ect link voltage in a DC link of the drive train to a first setpoint voltage. Recuperated braking energy can thus advantageously be stored in the energy storage unit, with it optionally being prevented at the same time that the braking energy is burnt up via braking resistors.

In one embodiment, the interface control device or the hybrid control device is set up to specify the first setpoint voltage, in particular depending on a second setpoint voltage obtained from the drive train control device.

In such a configuration, the drive train is optionally an – in particular serial – internal-combustion-engine-electric, optionally diesel-electric, drive train having a DC link in which at least one first electric machine, when operated as a generator, can feed in electrical energy, wherein the first electric machine or a second electric machine, when operated as a motor, can draw electrical energy from the DC link and supply it as drive power, wherein, when operated as a generator, it can feed recuperated braking energy into the DC link.

In such a conventional drive train without an energy storage device, the DC link voltage in the DC link is typically regulated to the second setpoint voltage of the drive train in the deceleration mode by the drive train control device through actuation of circuit breakers of a circuit breaker assembly electrically connected with braking resistors of a braking resistor assembly. So much recuperated braking energy is thus always output to the environment as heat via the braking resistors that the DC link voltage is kept at the level of the second setpoint voltage. The second setpoint voltage is optionally defined in the drive train control device.

In the embodiment proposed here, provision is made, in the deceleration mode, for the energy storage device to be used to regulate the DC link voltage to the first setpoint voltage by storing at least part of the recuperated braking energy in the energy storage unit.

In one embodiment, the first setpoint voltage is lower than the second setpoint voltage of the drive train. In this way, the energy storage device can successfully control the DC link voltage to the first setpoint voltage for as long as the total recuperated braking energy can be stored in the energy storage unit. If the energy storage unit is already too loaded, this means in particular that a state of charge (SOC) of the energy storage unit is so high that the entire recuperated braking energy can no longer be stored or no additional energy can be stored, or, if a recuperated braking power currently occurring is higher than a power that can be absorbed by the energy storage unit, the DC link voltage rises above the first setpoint voltage. In this case, it is advantageous that the drive train control device automatically regulates the DC link voltage to the second setpoint voltage. In this case, only that portion of the braking energy that cannot be absorbed by the energy storage unit is always burnt up via the braking resistors entirely automatically and without the need for additional complicated measures.

In one configuration, it is possible that the regulation of the DC link voltage to the first setpoint voltage – and optionally the specification of the first setpoint voltage – described here is at least partially taken over by the hybrid control device and/or the energy storage control device, wherein the interface control device only outputs to the hybrid control device a signal, as the hybrid control parameter, indicating that the deceleration mode is set and, if necessary, specifies the first setpoint voltage, in particular as a function of the second setpoint voltage.

As an alternative or in addition, the energy storage device, in particular the interface control device, is set up, in an acceleration mode, to determine a power request from at least one drive train signal of the drive train received via the first interface and to specify the at least one hybrid control parameter as a function of the determined power request.

In one embodiment, the energy storage device, in particular the interface control device, is set up to receive, as the at least one drive train signal, a first speed demand generated by the drive train control device for the power device of the drive train in the form of an internal combustion engine and, on the other hand, to receive a first excitation for the first electric machine of the drive train which is operated as a generator in acceleration mode and operatively connected to the internal combustion engine in terms of drive. The energy storage device, in particular the interface control device, is also set up to determine the power request from the first speed demand and the first excitation.

In one configuration, the energy storage device, in particular the interface control device, is additionally set up to also receive, as the at least one drive train signal, a driving demand position signal of a driving demand manipulator, in particular an accelerator pedal, and to check the plausibility of the power request based on the received driving demand position signal.

In one configuration, the interface control device is set up to output the power request itself as the hybrid control parameter to the hybrid control device. The hybrid control device is then optionally set up to specify the storage control parameter and optionally the at least one drive train control parameter depending on the hybrid control parameter and thus to operate, on the one hand, the energy storage unit and, on the other hand, the drive train.

In another configuration, the interface control device itself is set up to specify and output the storage control parameter and optionally the at least one drive train control parameter depending on the power request.

In one embodiment, the at least one drive train control parameter is, on the one hand, a second speed demand for the internal combustion engine and, on the other hand, a second excitation for the electric machine. The storage control parameter is optionally a parameter for actuating a DC-DC converter. The second speed demand and the second excitation deviate from the first speed request and the first excitation in a virtually complementary manner to a power associated with the storage control parameter and drawn from the energy storage unit or stored in the energy storage unit; in particular, the higher the portion of power produced from the energy storage unit in the power request, the lower the second speed demand and/or the second excitation can be selected, since the portion of power produced by the internal combustion engine is correspondingly lower – and vice versa.

The speed demand for the internal combustion engine – be it the first speed demand or the second speed demand – is optionally specified depending on a load point of the internal combustion engine, in particular in such a way that an efficiency of the internal combustion engine is as high as possible, optionally optimized. The actual power control is optionally carried out via the specification of the excitation. The speed regulation system of the internal combustion engine then adjusts the quantity of fuel injected depending on the excitation and the actual load applied.

Optionally, the interface control device is additionally set up, in acceleration mode, to specify the at least one drive train feedback parameter depending on the determined power request. In particular, it is advantageously ensured in this way that the power device of the drive train providing the drive power provides the complementary portion of the drive power which is not or cannot be applied in particular by the energy storage unit. To this end, the at least one drive train feedback parameter is optionally specified by the interface control device in such a way that the drive train control device receives, as the power to be applied, precisely that power portion in a simulated form and which is not or cannot be applied from the energy storage unit – or which, if necessary, must be provided additionally when the energy storage unit is to be charged.

In this case, the control or regulation of the provision of the drive power can optionally be carried out via speed regulation of a power device in the form of an internal combustion engine or – analogous to the deceleration mode – via regulation of the DC link voltage. In an optional configuration, feedforward control is carried out on the basis of the speed, and remaining deviations are corrected by regulating the DC link voltage.

In one embodiment, the interface control device is set up to specify, as the at least one drive train feedback parameter, a simulated actual speed of the internal combustion engine and to output same to the drive train control device, wherein the simulated actual speed is determined such that it corresponds to a fictitious actual speed of the internal combustion engine actuated using the first speed demand without the energy storage device. As an alternative or in addition, the interface control device is set up to specify, as the at least one drive train feedback parameter, a simulated actual excitation which is determined such that it corresponds to a fictitious actual excitation of the electric machine actuated using the first excitation without the energy storage device. In this way, the operation without the energy storage device is effectively simulated for the drive train control device.

The present invention also provides a drive train assembly having a drive train and having an energy storage device according to the present invention or an energy storage device according to one or more of the previously described embodiments, wherein drive train has a drive train control device, and wherein the energy storage device is operatively connected to the drive train in such a way that energy can be selectively stored by the drive train in the energy storage unit of the energy storage device and supplied to the drive train from the energy storage unit. The interface control device of the energy storage device is set up to receive at least one demand parameter from the drive train control device and to specify at least one hybrid control parameter depending on the at least one demand parameter. In particular, the advantages which have already been described above in conjunction with the interface control device or the energy storage device are provided in conjunction with the drive train assembly.

According to one development of the present invention, provision is made for the drive train to be in the form of an internal-combustion-engine, diesel-electric, diesel-mechanical or diesel-hydraulic drive train.

As an alternative or in addition, the energy storage device is in the form of an electrical or electrochemical energy storage unit, in particular a capacitor or battery, a pneumatic or hydropneumatic or a mechanical energy storage unit, in particular a flywheel.

The present invention also includes a motor vehicle having a drive train assembly according to the present invention or a drive train assembly according to one or more of the previously described embodiments. The motor vehicle is optionally selected from a group consisting of an excavator, a truck, a mining vehicle or construction vehicle, in particular a wheel loader or dump truck, a rail vehicle, a ship, for example a yacht, a ferry or a submarine, and a military vehicle, in particular an armored vehicle, for example a battle tank, infantry fighting tank, sniper tank, mine clearing tank or the like.

The present invention also provides a method for retrofitting – also referred to below as a retrofitting method – a drive train including a drive train control device and having an energy storage device, wherein the energy storage device is operatively connected to the drive train in such a way that energy can be selectively stored by the drive train in an energy storage unit of the energy storage device and supplied to the drive train from the energy storage unit, wherein an interface control device of the energy storage device is operatively connected to the drive train control device of the drive train in such a way that at least one demand parameter can be received by the drive train control device by way of the interface control device, wherein the interface control device can be used to specify at least one hybrid control parameter, depending on the at least one demand parameter. In particular, the advantages which have already been described previously in conjunction with the interface control device, the energy storage device or the drive train assembly are provided in conjunction with the retrofitting method. In particular, the drive train control device remains advantageously unchanged during retrofitting, and only the energy storage device together with the interface control device are additionally implemented and suitably operatively connected. The interface control device advantageously ensures that the drive train control device can continue to function as if the energy storage device were not present, thus not requiring in particular any changed parametrization or other adaptation of the drive train control device.

In one embodiment, a hybrid control device is retrofitted with the energy storage device, which is operatively connected to the interface control device and optionally to an energy storage control device of the energy storage device.

The various control devices are in particular operatively connected to one another in such a way that the functionality described previously in conjunction with the interface control device or the energy storage device, in particular with regard to the drive train control parameter and the at least one drive train feedback parameter, is provided.

In one configuration, at least one data output of the interface control device is operatively connected to at least one sensor input of the drive train control device, in particular in order to output the at least one drive train feedback parameter to the drive train control device.

The present invention also provides a method for operating – also referred to below as operating method – a drive train including a drive train control device in combination with an energy storage device, in particular an energy storage device according to the present invention or an energy storage device according to one or more of the previously described embodiments, wherein an interface control device of the energy storage device, in particular an interface control device according to the present invention or an interface control device according to one or more of the previously described embodiments, is used to specify, depending on at least one demand parameter of the drive train control device, a hybrid control parameter, wherein the energy storage device is operated using the hybrid control parameter. In particular, the advantages which have already been described above in conjunction with the interface control device, the energy storage device, the drive train assembly or the retrofitting method are provided in conjunction with the operating method. In the operating method, a drive train assembly according to the present invention or a drive train assembly according to one or more of the previously described embodiments is optionally operated.

The operating method is optionally characterized by at least one method step or a combination of method steps which have previously been explained explicitly or implicitly in conjunction with the mode of operation of the interface control device, the energy storage device or the drive train assembly.

The present invention also provides a computer program including machine-readable instructions, that is to say commands, on the basis of which an interface control device, in particular an interface control device according to the present invention or an interface control device according to one or more of the previously described embodiments, is prompted to execute an operating method according to the present invention or an operating method according to one or more of the previously described embodiments when the computer program runs on the interface control device. In particular, the advantages which have already been described above in conjunction with the interface control device, the energy storage device, the drive train assembly, the retrofitting method or the operating method are provided in conjunction with the computer program.

The present invention also provides an electronic storage device having a computer program according to the present invention or a computer program according to one or more of the previously described embodiments stored on the electronic storage device. In particular, the advantages which have already been described above in conjunction with the interface control device, the energy storage device, the drive train assembly, the retrofitting method, the operating method or the computer program are provided in conjunction with the electronic storage device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic illustration of an exemplary embodiment of a drive train assembly having an exemplary embodiment of an interface control device for the integration of at least one energy storage device into a drive train;

FIG. 2 shows a schematic illustration of an exemplary embodiment of a method for operating the drive train assembly according to FIG. 1 in a first operating mode;

FIG. 3 shows a schematic illustration of a method for operating a drive train without an energy storage device in a second operating mode; and

FIG. 4 shows a schematic illustration of the exemplary embodiment of the method for operating the drive train assembly according to FIG. 1 in the second operating mode.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

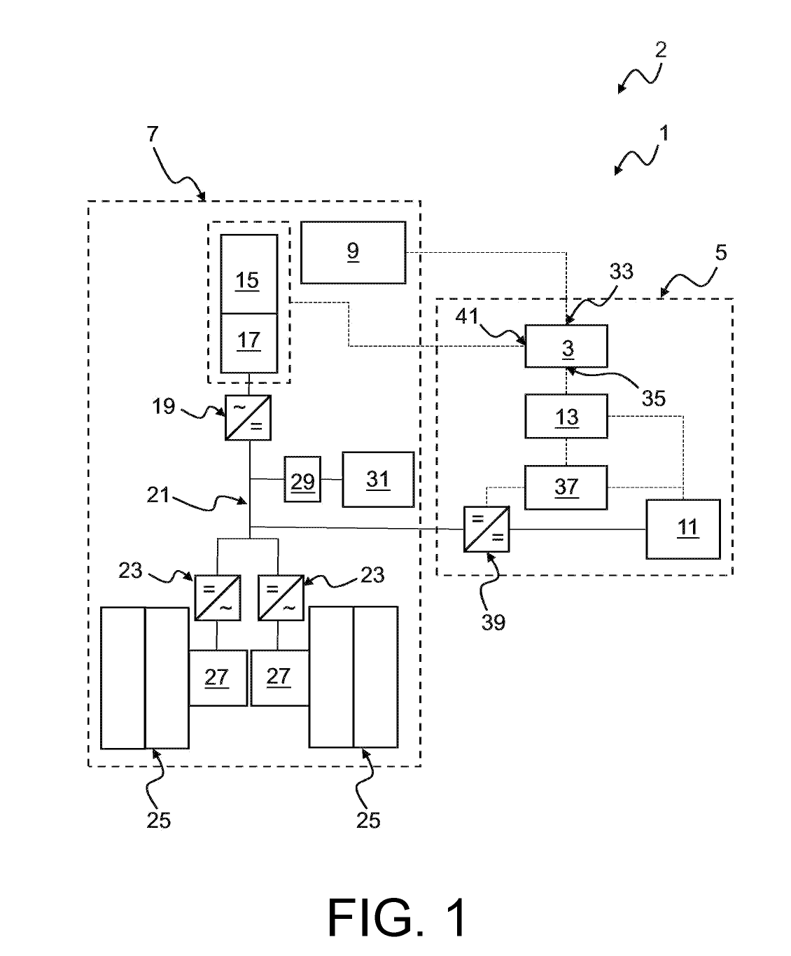

FIG. 1 shows a schematic illustration of an exemplary embodiment of a drive train assembly 1 of a motor vehicle 2 having an exemplary embodiment of an energy storage device 5 including an interface control device 3 for integration into a drive train 7.

The motor vehicle 2 is optionally selected from a group consisting of an excavator, a truck, a mining vehicle or construction vehicle, in particular a wheel loader or dump truck, a rail vehicle, a ship, for example a yacht, a ferry or a submarine, and a military vehicle, in particular an armored vehicle, for example a battle tank, infantry fighting tank, sniper tank, mine clearing tank or the like.

The drive train assembly 1 has a drive train control device 9. The energy storage device 5 is operatively connected to the drive train 7 in such a way that energy can be selectively stored in an energy storage unit 11 of the energy storage device 5 from the drive train 7 and supplied to the drive train 7 from the energy storage unit 11. The energy storage unit 11 may include, for example, multiple battery cells and one or more battery management systems (not shown). The interface control device 3 is set up to receive at least one demand parameter from the drive train

control device 9 and, depending on the at least one demand parameter, to specify to the energy storage device 5 at least one hybrid control parameter.

The energy storage device 5 also includes a hybrid control device 13 which is operatively connected to the interface control device 3 in order to receive the hybrid control parameter. The hybrid control device 13 and the interface control device 3 can advantageously be implemented in a joint module (not shown) as hardware or software. As an alternative or in addition, the hybrid control device 13 can also be directly operatively connected to the energy storage unit 11.

In the exemplary embodiment illustrated here, the energy storage unit 11 is in the form of an electrical energy storage unit, in particular a battery.

In the exemplary embodiment illustrated here, the drive train 7 is in the form of a diesel-electric drive train 7 and has an internal combustion engine 15 and a first electric machine 17 operatively connected in terms of drive to the internal combustion engine 15. The first electric machine 17 can selectively be operated as a motor or as a generator, but in the exemplary embodiment illustrated here is regularly operated as a generator and driven by the internal combustion engine 15. Said first electric machine is electrically connected to a DC link 21 via a first inverter 19. The DC link 21 is in turn electrically connected via second inverters 23 to electric hub motors 27, as second electric machines, arranged on wheels 25 of the motor vehicle 2, wherein the hub motors 27 can be operated in an acceleration mode as motors and in a deceleration mode as generators. Furthermore, the DC link circuit 21 is electrically connected via a plurality of circuit breakers of a circuit breaker assembly 29 to a plurality of braking resistors of a braking resistor assembly 31.

The drive train control device 9 has a plurality of operating modes, in particular a deceleration mode and an acceleration mode. In the acceleration mode, the second inverters 23 are actuated to operate the hub motors 27 as motors and to provide them with electrical power from the DC link 21 to accelerate the wheels 25. At the same time, the first electric machine 17 is driven by the internal combustion engine 15 in order to feed electrical power into the DC link 21. In the deceleration mode, the second inverters 23 are actuated to operate the hub motors 27 as generators, wherein electrical braking power is recuperated and fed into the DC link 21 via the second inverters 23. This recuperated electrical braking power is converted into heat via the suitably actuated circuit breaker assembly 29 and the braking resistor assembly 31 and dissipated to the environment, thus burnt up.

The drive train control device 9 is thus set up to operate the drive train 7 in a conventional manner without the energy storage device 5.

According to the idea on which the invention is based, provision is now made to retrofit the drive train 7 while retaining the drive train control device 9, in particular without modification thereof, with the energy storage device 5. The interface control device 3 is accordingly set up for the integration of the energy storage device 5 for selectively storing and delivering drive energy from and into the drive train 7.

For this purpose, it has at least one first interface 33 set up to receive the at least one demand parameter of the drive train 7 and set up to specify, depending on the at least one demand parameter, the at least one hybrid control parameter and in particular to output the at least one hybrid control parameter via a second interface 35 to the hybrid control device 13. The interface control device 3 provides an interface that enables simple integration of the energy storage device 5 into the existing drive train 7, taking into account the portions of energy or power now absorbed or provided by the energy storage unit 11, which is described in more detail below.

The demand parameter is optionally selected from a group consisting of the operating mode, specifically the deceleration mode or acceleration mode, a power demand, a speed demand, in particular a setpoint speed to be controlled, an excitation – in particular of the first electric machine 17 – and a combination of at least two of the above parameters.

In the exemplary embodiment illustrated here, the hybrid control parameter is output via the second interface 35 to the hybrid control device 13, which in turn specifies, depending on the hybrid control parameter, a storage control parameter and outputs this to an energy storage control device 37.

The energy storage unit 11 is electrically connected via a DC-DC converter 39 to the DC link 21 in order – in particular depending on the actuation of the DC-DC converter 39 by the energy storage control device 37 – to feed in energy from the DC link 21 or to deliver it to the DC link 21.

The interface control device 3 is optionally set up to specify, depending on the at least one hybrid control parameter and/or the at least one demand parameter, at least one drive train control parameter and to output the at least one drive train control parameter via the at least one first interface 33 – or via a third interface 41 illustrated here for a better overview – to the drive train 7.

The interface control device 3 is also optionally additionally set up to specify at least one drive train feedback parameter, optionally depending on the at least one demand parameter and optionally depending on the at least one hybrid control parameter, and to output the drive train feedback parameter via the at least one first interface 33 or the third interface 41 to the drive train 7. The at least one drive train feedback parameter is specified by the interface control device 3 in such a way that the drive train 7 can be operated by the drive train control device 9 as if the energy storage device 5 were not present. In this case, a function of the drive train without the at least one energy storage device 5 is projected for the drive train control device 9, or – in other words – the interface control device 3 simulates the function of the drive train 7 without the energy storage device 5 for the drive train control device 9.

The at least one drive train feedback parameter is optionally selected from a group consisting of a simulated actual speed of the internal combustion engine 15, a simulated actual speed of a radiator fan of the braking resistor assembly 31, a simulated electrical current between the circuit breaker assembly 29 and the braking resistor assembly 31, a simulated excitation in particular of the first electric machine 17, a simulated electric current in particular of the first electric machine 17 – in particular in an excitation winding, a simulated voltage in particular of the first electric machine 17 – in particular at the excitation winding, and a combination of at least two of the parameters mentioned.

In the context of a retrofitting method of the drive train 7 having the drive train control device 9 and the energy storage device 5, the energy storage device 5 is retrofitted to the drive train 7, wherein the energy storage device 5 is operatively connected to the drive train 7 in such a way that energy can be selectively stored by the drive train 7 in the energy storage unit 11 and supplied to the drive train 7 from the energy storage unit 11. The interface control device 3 of the energy storage device 5 is operatively connected to the drive train control device 9 for this purpose in such a way that the at least one demand parameter can be received by the drive train control device 9 by way of the interface control device 3, wherein the interface control device 3 can be used to specify the at least one hybrid control parameter depending on the at least one demand parameter.

In the context of an operating method for operating the drive train 7 in combination with the energy storage device 5, a hybrid control parameter is specified by the interface control device 3 depending on the at least one demand parameter, wherein the energy storage device 5 is operated using the hybrid control parameter.

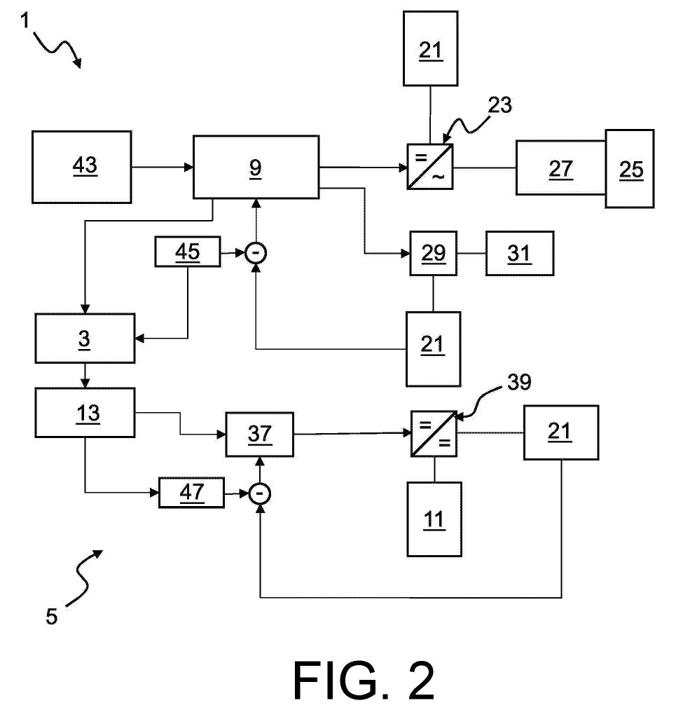

FIG. 2 shows a schematic illustration of an exemplary embodiment of a method for operating the drive train assembly 1 according to FIG. 1 in a first operating mode, namely a deceleration mode.

Like and functionally similar elements are provided with the same reference signs in all figures, and therefore reference is made to the previous description in each case.

In response to a brake demand position signal of a brake demand manipulator 43, in particular a brake pedal, the drive train control device 9 switches to the deceleration mode and actuates the second inverters 23 in such a way that brake energy from the wheels 25 is recuperated by the hub motors 27 and is fed as electrical energy into the DC link 21. At the same time, without the energy storage device 5, the control device 9 conventionally regulates the DC link voltage in the DC link 21 by suitable actuation of the circuit breaker assembly 29 to a setpoint voltage 45 – described as a second setpoint voltage here to delimit it from a first setpoint voltage 47 described below – by burning up excess electrical energy via the braking resistor assembly 31.

In the exemplary embodiment illustrated here, the deceleration mode is now received by way of the interface control device 3 as a demand parameter transmitted by the control device 9. In addition, the interface control device 3 also receives the second setpoint voltage 45. It then specifies the hybrid control parameter and outputs it to the hybrid control device 13 in such a way that it includes information about the deceleration mode and information for calculating a first setpoint voltage 47 or directly includes the first setpoint voltage 47. The hybrid control device 13 then specifies a corresponding storage control parameter and outputs it to the storage control device 37.

The storage control device 37 now regulates the DC link voltage to the first setpoint voltage 47 by corresponding actuation of the DC-DC converter 39, in particular in such a way that as much electrical energy as possible from the DC link 21 is stored in the energy storage unit 11.

Although the previously explained regulation mechanism of the drive train control device 9 to the second setpoint voltage 45 simultaneously remains active, it is ineffective as long as the DC link voltage is effectively regulated by the storage control device 37 to the first setpoint voltage 47, since the first setpoint voltage 47 is lower than the second setpoint voltage 45. Only when the storage control device 37 no longer succeeds in regulating the DC link voltage to the first setpoint voltage 47, because, for example, the energy storage unit 11 can no longer absorb enough energy or the electrical power required for the regulation, the DC link voltage also rises again above the second setpoint voltage 45, wherein the regulation mechanism of the drive train control device 9 then engages automatically, and the excess energy or power is then readily burnt up via the circuit breaker assembly 29 and the braking resistor assembly 31.

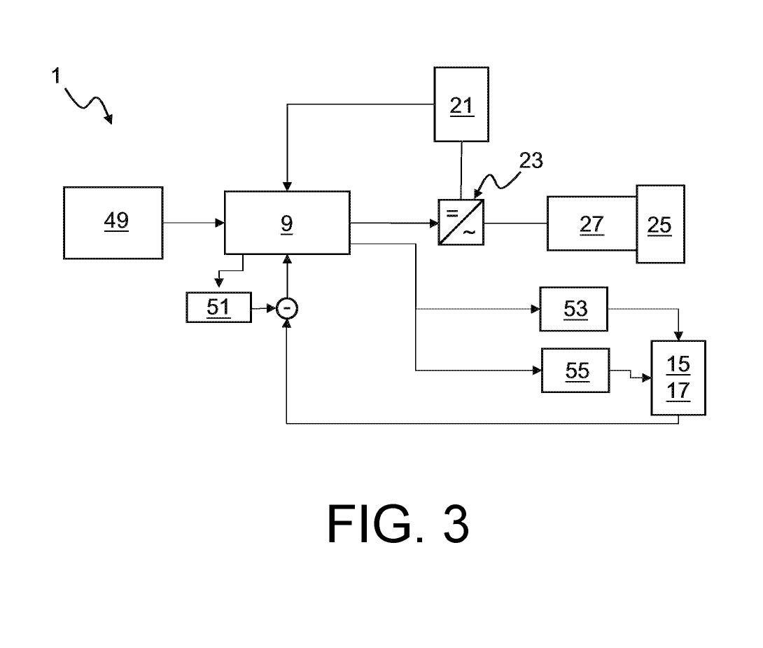

FIG. 3 shows a schematic illustration of a method for operating a drive train 7 without the energy storage device 5 in a second operating mode.

The drive train control device 9 receives a driving demand position signal of a driving demand manipulator 49, in particular an accelerator pedal, and then actuates the second inverters 23 in such a way that the hub motors 27 are operated as motors, and drive power from the DC link 21 is supplied to the drive wheels 25.

In order to provide the necessary electrical power, the drive train control device 9 also specifies, depending on the driving demand position signal, firstly a setpoint speed 51 – referred to as second setpoint speed to distinguish it from a first setpoint speed 61 described below – a speed demand 53 – referred to as second speed demand to distinguish it from a first speed demand 57 described below – and an excitation 55 – referred to as second excitation to distinguish it from a first excitation 59 described below. It outputs the second speed demand 53 and the second excitation 55 to the unit composed of internal combustion engine 15 and electric machine 17, which is described here briefly and somewhat laxly as "genset 15, 17".

In addition, it is shown here that the drive train control device 9 regulates the genset 15, 17 to the second setpoint speed 51. In fact, the genset 15, 17 is optionally subjected to feedforward control by way of the second setpoint speed 51, wherein actual power regulation in response to the DC link voltage in the DC link 21 takes place, which is only very schematically indicated here.

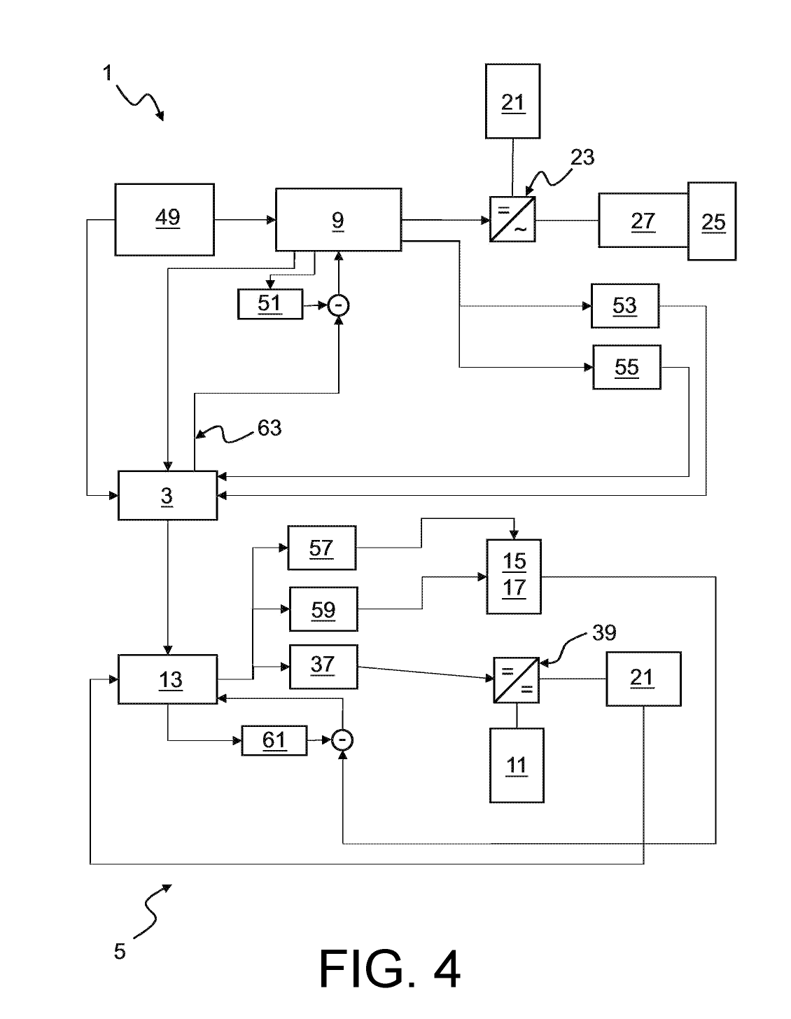

FIG. 4 shows a schematic illustration of the exemplary embodiment of the method for operating the drive train assembly 1 according to FIG. 1 in the second operating mode.

In this case, the interface control device 3 receives the acceleration mode, the second speed request 53 and the second excitation 55 as a drive train parameter from the drive train control device 9. It is possible that the interface control device 3 also receives the second setpoint speed 51, which is not specifically shown here for the sake of clarity. The interface control device 3 also receives the driving demand position signal.

The interface control device 3 is set up to determine a power request from the second speed request 53 and the second excitation 55 in the acceleration mode. It is possible that the determined power request is checked for plausibility based on the driving demand position signal. The interface control device 3 is also set up to output the power request to the hybrid control device 13 as a hybrid control parameter.

The hybrid control device 13 is set up to specify the first speed demand 57, the first excitation 59 and the storage control parameter for the energy storage control device 37 depending on the power request. In this case, the hybrid control device 13 specifies a distribution of the drive power to be applied in relation to the power request, on the one hand, to the genset 15, 17 and, on the other hand, to the energy storage unit 11 and determines the first speed demand 57, the first excitation 59 and the storage control parameters depending on this distribution. Thus, as a rule – if sufficient power can be provided by the energy storage unit 11 – the first speed demand 57 and the first excitation 59 differ from the second speed demand 53 and the second excitation 55; in particular they are typically smaller in each case. The first speed request 57 and the first excitation 59 are, in particular, drive train control parameters.

The genset 15, 17 is now actuated using the first speed request 57 and the first excitation 59, and the energy storage control device 37 actuates the DC-DC converter 39 using the storage control parameter.

The hybrid control device 13 optionally also determines a second setpoint speed 61 and determines the first speed demand 57 and the first excitation 59 so that the internal combustion engine 15 is regulated to the second setpoint speed 61, and/or that the internal combustion engine 15 is subjected to feedforward control using the second setpoint speed 61. Here, too, the actual power regulation is optionally carried out by the hybrid control device 13 in response to the DC link voltage in the DC link 21, which in turn is only roughly schematically indicated.

In the acceleration mode, the interface control device 3 specifies a simulated actual speed 63 as the at least one drive train feedback parameter depending on the determined power request and outputs same to the drive train control device 9. In this case, the simulated actual speed 63 corresponds in particular to a fictitious speed which would be set at the internal combustion engine 15 when it is actuated using the second speed demand 53 without the energy storage device 5. In this way, it is ensured that, when the operation of the drive train control device 9 remains unchanged, the second speed demand 53 and the second excitation 55 always correspond to the actual power request.

As an alternative or in addition, the interface control device 3 can be set up to specify, as the at least one drive train feedback parameter, a simulated actual excitation which is determined such that it corresponds to a fictitious actual excitation of the first electric machine 17 actuated using the second excitation 55 without the energy storage device 5.

It is possible that the interface control device 3 additionally simulates other signal inputs or the like for the drive train control device 9 in order to replicate the operation without the energy storage device 5.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An interface control device, comprising:
the interface control device, which is configured for integrating at least one energy storage device for selectively storing a drive energy in, and delivering the drive energy to, a drive train, the interface control device including at least one first interface which is configured for receiving at least one demand parameter of the drive train, the interface control device being configured for specifying, depending on the at least one demand parameter, at least one hybrid control parameter for operating the at least one energy storage device.

2. The interface control device according to claim 1, wherein the interface control device is configured for at least one of:
specifying, depending on at least one of the at least one hybrid control parameter and the at least one demand parameter, at least one drive train control parameter and for outputting the at least one drive train control parameter to the drive train; and
specifying at least one drive train feedback parameter and outputting the at least one drive train feedback parameter to the drive train.

3. The interface control device according to in claim 2, wherein the interface control device is configured for specifying the at least one drive train feedback parameter in such a way that a function of the drive train without the at least one energy storage device is projected for a drive train control device of the drive train that receives the at least one drive train feedback parameter.

4. The interface control device according to claim 1, wherein the interface control device is configured for at least one of:
specifying, depending on at least one of the at least one hybrid control parameter and the at least one demand parameter, at least one drive train control parameter and for outputting the at least one drive train control parameter – via the at least one first interface or an additional interface – to the drive train; and
specifying at least one drive train feedback parameter and outputting the at least one drive train feedback parameter – via the at least one first interface or an additional interface – to the drive train.

5. A drive train assembly, comprising:
a drive train including a drive train control device; and
an energy storage device configured for retrofitting on a drive train, the energy storage device including an energy storage unit, an energy storage control device, and an interface control device which is operatively connected to the energy storage control device, the interface control device being configured for integrating the energy storage device for selectively storing a drive energy in, and delivering the drive energy to, the drive train, the interface control device including at least one first interface which is configured for receiving at least one demand parameter of the drive train, the interface control device being further configured for specifying, depending on the at least one demand parameter, at least one hybrid control parameter for operating the energy storage device, the energy storage device being operatively connected to the drive train and thereby the drive train assembly being configured for energy being selectively stored by the drive train in the energy storage unit of the energy storage device and supplied to the drive train from the energy storage unit, the interface control device of the energy storage device being configured for receiving the at least one demand parameter from the drive train control device and, depending on the at least one demand parameter, for specifying the at least one hybrid control parameter.

6. The drive train assembly according to claim 5, wherein at least one of:
the drive train is formed as an internal-combustion-engine drive train, a diesel-electric drive train, a diesel-mechanical drive train, or a diesel-hydraulic drive train; and
the energy storage unit of the energy storage device is formed as an electrical energy storage unit, a pneumatic energy storage unit, a hydropneumatic energy storage unit, an electrochemical energy storage unit, or a mechanical energy storage unit.

7. The drive train assembly according to claim 6, wherein at least one of: (a) the electrochemical storage device is formed as a capacitor or a battery; and (b) the mechanical energy storage unit is formed as a flywheel.

8. The drive train assembly according to claim 5, wherein the energy storage device is configured at least one of:
in a deceleration mode, to regulate a DC link voltage in a DC link of the drive train to a first setpoint voltage; and
in an acceleration mode, to determine, from at least one drive train signal of the drive train received via the at least one first interface, a power request and to specify the at least one hybrid control parameter.

9. The drive train assembly according to claim 5, wherein the energy storage device is configured at least one of:
in a deceleration mode, to regulate a DC link voltage in a DC link of the drive train to a first setpoint voltage which is lower than a second setpoint voltage of the drive train; and
in an acceleration mode, to determine, from at least one drive train signal of the drive train received via the at least one first interface, a power request and to specify the at least one hybrid control parameter and a drive train feedback parameter depending on the power request that is determined.

10. A method for retrofitting a drive train, the method comprising the steps of:
providing the drive train and an energy storage device, the drive train including a drive train control device, the energy storage device being retrofitted to the drive train;
operatively connecting the energy storage device to the drive train in such a way that energy is selectively stored by the drive train in an energy storage unit of the energy storage device and is supplied to the drive train from the energy storage unit;
operatively connecting an interface control device of the energy storage device to the drive train control device of the drive train in such a way that at least one demand parameter is received by the drive train control device by way of the interface control device; and
using the interface control device to specify at least one hybrid control parameter, depending on the at least one demand parameter.

11. The method according to claim 10, wherein the method includes operating the drive train, wherein the energy storage device is operated using the at least one hybrid control parameter.

12. The method according to claim 11, wherein:
the interface control device is configured for integrating the energy storage device for selectively storing a drive energy in, and delivering the drive energy to, the drive train, the interface control device including at least one first interface which is configured for receiving the at least one demand parameter of the drive train, the interface control device being configured for specifying, depending on the at least one demand parameter, the at least one hybrid control parameter for operating the energy storage device; and
the energy storage device includes an energy storage control device and an interface control device which is operatively connected to the energy storage control device.

13. The method according to claim 12, wherein the operating of the drive train includes using a computer program including a plurality of machine-readable instructions, on the basis of which the interface control device is prompted to execute the operating of the drive train when the computer program runs on the interface control device.

14. The method according to claim 13, wherein the computer program is stored on an electronic storage device.
